(19) United States
(12) Patent Application Publication
(10) Pub. No.: US 2026/0244786 A1
(43) Pub. Date: Aug. 20, 2026

(54) DISTRIBUTED GENERATION OF DIFFERENTIAL PRIVACY NOISE

(71) Applicant: Google LLC, Mountain View, CA (US)

(72) Inventors: Pasin Manurangsi, Bangkok (TH); Charles Harrison, Mountain View, CA (US)

(21) Appl. No.: 19/412,221

(22) Filed: Dec. 8, 2025

Related U.S. Application Data
(60) Provisional application No. 63/759,833, filed on Feb. 18, 2025.

(51) Int. Cl. G06F 21/62

(52) U.S. Cl. CPC G06F 21/6245

(57) ABSTRACT

Methods, systems, and apparatus, including computer programs encoded on a computer storage medium, for generating differential privacy noise and applying the noise to data. In one aspect, a method includes sending, to each noise generator or multiple noise generators, noise generation data including differential privacy parameters and a number of noise generators that are generating shares of differential privacy parameters. A share of differential privacy noise is received from two or more of the noise generators. Each share is generated based on the noise generation data. Each share of the differential privacy noise is generated by obtaining multiple subsamples from a negative binomial distribution using input parameters comprising a ratio between a scaling factor and the number of noise generators. Each share of noise received from the two or more noise generators is combined to obtain total noise that is applied to data of a dataset.

### CROSS-REFERENCE TO RELATED APPLICATION

This application claims priority to U.S. Provisional Application No. 63/759,833, filed on Feb. 18, 2025. The disclosure of the prior application is considered part of and is incorporated by reference in the disclosure of this application.

### TECHNICAL FIELD

This specification generally relates to data security, data privacy, differential privacy, and distributed computing.

### BACKGROUND

Differential privacy is a framework for protecting the privacy of individuals when their data is included in datasets. For example, differential privacy can prove limits on how much information an outputted result that is based on the dataset may reveal about an individual item in the dataset. Differential privacy can be used to generate aggregate reports and/or statistical information while preserving the privacy of users for which data is included in the reports and/or statistical information. In general, noise can be added to data such that data provided in response to a query is differentially private. However, there is a tradeoff between the amount of noise added and the accuracy and utility of the data provided in response to the queries.

### SUMMARY

This specification describes methods, computer systems, and apparatus, including computer programs encoded on computer storage media, for generating noise for differential privacy in a distributed manner. Using the techniques described in this document, differential privacy can be achieved in a distributed manner, where multiple parties add independent noise such that their sum protects the overall dataset with differential privacy. Each party can sample their noise from the decomposition of an infinitely divisible distribution. In some implementations, the noise can be generated and sampled using a multi-scale discrete Laplace mechanism, a generalized discrete Laplace mechanism, a continuous transformed multi-scale discrete Laplace mechanism, or a continuous transformed generated discrete Laplace mechanism.

In general, one innovative aspect of the subject matter described in this specification can be embodied in methods that include the actions of sending, to each noise generator or multiple noise generators, noise generation data comprising differential privacy parameters and a number of noise generators that are generating shares of differential privacy parameters; receiving, from two or more of the noise generators, a share of differential privacy noise generated based on the noise generation data, wherein the share of the differential privacy noise is generated by obtaining multiple subsamples from a negative binomial distribution using input parameters comprising a ratio between a scaling factor and the number of noise generators; combining each share of noise received from the two or more noise generators to obtain total noise; and applying the noise to data of a dataset. Other implementations of this aspect include corresponding apparatus, systems, and computer programs, configured to perform the aspects of the methods, encoded on computer storage devices.

These and other embodiments can each optionally include one or more of the following features. In some aspects, the ratio between a scaling factor and the number of noise generators includes a number of successes parameter for the negative binomial distribution. The input parameters can include a success probability parameter. The success probability parameter can be equal to (1−e^{-α}).

In some aspects, the scaling factor has a value less than one.

In some aspects, the multiple subsamples include two subsamples and the share of the differential privacy noise is generated by determining a difference between the two subsamples.

In some aspects, the share of the differential privacy noise is generated by obtaining multiple subsamples from a gamma distribution. The multiple subsamples from the negative binomial distribution can include two subsamples from the negative binomial distribution. The multiple subsamples from the gamma distribution can include two subsamples from the gamma distribution. The share of the differential privacy noise can be generated by determining a first difference between the two subsamples from the negative binomial distribution, determining a second difference between the two subsamples from the gamma distribution, and determining a sum of the two differences. Determining the sum of the two differences can include scaling the first difference prior to determining the sum.

In some aspects, obtaining multiple subsamples from a negative binomial distribution includes obtaining the multiple subsamples at different scales. The multiple subsamples from the negative binomial distribution can include two subsamples from the negative binomial distribution. The share of the differential privacy noise can be generated by, for each different scale, determining a difference between the two subsamples for the scale and determining a sum of the differences. The share of the differential privacy noise can be generated by obtaining two subsamples from a gamma distribution. The share of the differential privacy noise can include a sum of (i) a difference between the two subsamples from a gamma distribution and (ii) the sum of the differences.

Particular embodiments of the subject matter described in this specification can be implemented so as to realize one or more of the following advantages. The techniques described in this document can generate noise distributions for differential privacy that are infinitely divisible meaning that the noise can be added in a distributed manner, e.g., by multiple parties or computers. An infinitely divisible distribution is a probability distribution that can be expressed as a sum of a number, n, of independent and identically distributed random variables, where n is any positive integer. The described noise distributions significantly reduce the error compared to other distributions (e.g., Laplace, discrete Laplace, Arete, staircase) where the differential privacy parameter (∈) is large (e.g., having a value greater than one) in what is considered a low-privacy regime. The described techniques also include sampling techniques that enable distributed noise generation while also reducing the error imposed by the differential privacy noise. The techniques for generating noise distributions and sampling the noise from the noise distributions minimize (or at least reduce) the mean squared error (MSE) of the results of a query subject to a query-independent additive noise mechanism.

Reducing the amount of noise applied to data and the resultant decrease in error also results in less use of a privacy budget for each query or a combination of queries. The privacy budget quantifies the total amount of information that can be learned about an individual's data from a dataset. Reducing the amount of privacy budget used for each query enables more queries on a dataset without leaking an individual's data and/or enables enhanced privacy for the same number of queries. Thus, the data can be used more effectively by consumers of the data without risking data leaks.

The generalized discrete Laplace distribution noise addition mechanisms described in this document applies even when some parties drop out. For example, if the mechanism is performed expecting n parties, but only 0.9n parties participate, the privacy guarantees are still provided.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which differential privacy noise is generated.

FIG. 2 is a flow diagram of an example process for generating differential privacy noise.

FIG. 3 is a flow diagram of an example process for generating differential privacy noise.

FIG. 4 is a block diagram of an example computer system.

Like reference numbers and designations in the various drawings indicate like elements.

### DETAILED DESCRIPTION

In general, this specification describes systems and techniques for generating noise for differential privacy (“differential privacy noise”) using noise distributions and for sampling from the noise distributions for noise to add to data to make the data differentially private. The noise can be generated in a distributed manner by computers of multiple parties using, for example, a multi-scale discrete Laplace mechanism, a generalized discrete Laplace mechanism, a continuous transformed multi-scale discrete Laplace mechanism, or a continuous transformed generated discrete Laplace mechanism.

Differential privacy (DP) is a widely accepted, formal notion of privacy which bounds the sensitive information revealed by an algorithm. While there are various types of differential privacy, two common ones are pure-DP and ε-DP which bounds the privacy loss to ε>0. The differential privacy parameter (ε) is a metric of privacy loss which can control the level of privacy of a DP mechanism. The differential privacy parameter δ is a probability of privacy leakage. As a definition, a randomized mechanism M:X^{d}→y satisfies ε-DP if, for all x, x′∈X^{d} differing in a single entry, Pr[M(x)∈S]≤e^{ε}Pr[M(x′)∈S] for all measurable S⊆Y.

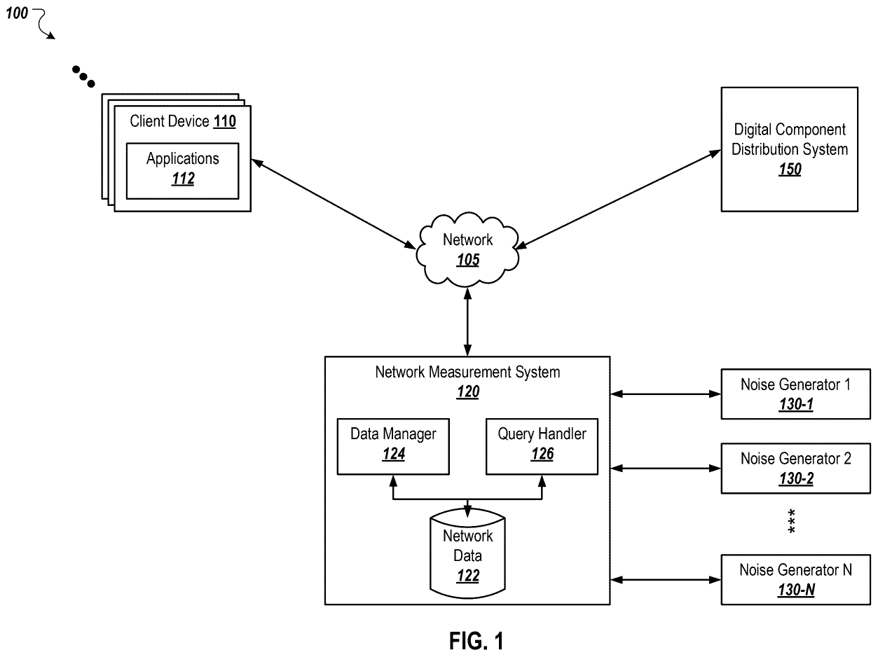

FIG. 1 is a block diagram of an example environment 100 in which a network measurement system 120 generates differentially private data. The environment 100 includes a data communication network 105, such as a local area network (LAN), a wide area network (WAN), the Internet, a mobile network, or a combination thereof. The data communication network 105 connects client devices 110 with a network measurement system 120 and a digital component distribution system 150. Although not shown in FIG. 1, the network 105 can also connect the network measurement system 120 with noise generators 130. The environment 100 can include any number “N” of noise generators 130, e.g., noise generators 130-1 to 130-N, where N is a positive integer. In implementations in which noise is generated in a distributed manner, N is a positive integer that is greater than or equal to two.

As described in more detail below, the noise generators 130 generate differential privacy noise that can be applied to data of a dataset to make data generated from the dataset differentially private. Each noise generator 130 can be implemented as one or more computers in one or more locations. As described in more detail below, the noise generators 130 can generate noise individually (e.g., as a sole source of noise) or in a distributed manner (e.g., where the noise generated by multiple noise generators 130 is applied to data and combined). Each noise generator 130 can be operated by a different party, e.g., a different organization or other entity.

The noise can be applied to any type of data. One example type of data is network measurement data related to the distribution of digital components across the network 105.

This network measurement data can include, for example, the number of presentations of digital components, the number of unique users to which a digital component has been presented, the number of user interactions with the digital components, the number of conversion events resulting from presentations of the digital components, subsets of these counts for various time periods, locations, etc., and/or other data related to digital components.

As used throughout this specification, the “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files and include advertising information, such that an advertisement is a type of digital component. For example, the digital component may be content that is intended to supplement the content of a web page or other resource presented by the application 112. More specifically, the digital component may include digital content that is relevant to the resource content (e.g., the digital component may relate to the same topic as the web page content, or to a related topic). The provision of digital components can thus supplement, and generally enhance, the web page or application content.

Further to the descriptions throughout this document, a user may be provided with controls (e.g., user interface elements with which a user can interact) allowing the user to make an election as to both if and when systems, programs, or features described herein may enable the collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no apparently personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

A client device 110 is an electronic device capable of requesting and receiving online resources over the network 105. Example client devices 110 include personal computers, gaming devices, mobile communication devices, digital assistant devices, augmented reality devices, virtual reality devices, and other devices that can send and receive data over the network 105. A client device 110 can also include a digital media device, e.g., a streaming device that plugs into a television or other display to stream videos to the television.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

The client device 110 can include applications 112, such as web browsers and/or native applications, to facilitate the sending and receiving of data over the network 105. A native application is an application developed for a particular platform or a particular device (e.g., mobile devices having a particular operating system). Although operations may be described as being performed by the client device 110, such operations may be performed by an application 112 running on the client device 110.

The applications 112 can present electronic resources, e.g., web pages, application pages, other application content, or electronic documents, to a user of the client device 110. The electronic resources can include digital component slots for presenting digital components with the content of the electronic resources. A digital component slot is an area of an electronic resource (e.g., web page or application page) for displaying a digital component. A digital component slot can also refer to a portion of an audio and/or video stream (which is another example of an electronic resource) for playing a digital component.

When the application 112 loads a resource that includes a digital component slot, the application 112 can generate a digital component request that requests a digital component for display in the digital component slot. In some implementations, the digital component slot and/or the resource can include code (e.g., scripts) that cause the application 112 to request a digital component from the digital component distribution system 150.

The client device 110 can present an electronic document, which is a type of electronic resource. An electronic document is data that presents a set of content at a client device 110. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices can also be referred to as electronic resources or electronic documents. Electronic documents can be provided to client devices 110 by electronic document servers.

For example, the electronic document servers can include servers that host publisher websites. The electronic document servers can be connected to the network 105. In this example, the client device 110 can initiate a request for a given publisher webpage, and the electronic server that hosts the given publisher webpage can respond to the request by sending machine executable instructions that initiate presentation of the given webpage at the client device 110.

In another example, the electronic document servers can include app servers from which client devices 110 can download apps. The app servers can be connected to the network 105. In this example, the client device 110 can download files required to install an app at the client device 110, and then execute the downloaded app locally (i.e., on the client device). Alternatively, or additionally, the client device 110 can initiate a request to execute the app, which is transmitted to a cloud server. In response to receiving the request, the cloud server can execute the application and stream a user interface of the application to the client device 110 so that the client device 110 does not have to execute the app itself. Rather, the client device 110 can present the user interface generated by the cloud server's execution of the app and communicate any user interactions with the user interface back to the cloud server for processing.

Electronic documents can include a variety of content. For example, an electronic document can include native content that is within the electronic document itself and/or does not change over time. Electronic documents can also include dynamic content that may change over time or on a per-request basis. For example, a publisher of a given electronic document can maintain a data source that is used to populate portions of the electronic document. In this example, the given electronic document can include a script that causes the client device 110 to request content (e.g., a digital component) from the data source when the given electronic document is processed (e.g., rendered or executed) by a client device 110 (or a cloud server). The client device 110 (or cloud server) integrates the content (e.g., digital component) obtained from the data source into the given electronic document to create a composite electronic document including the content obtained from the data source.

In some situations, a given electronic document can include a digital component script that references the digital component distribution system 150, or a particular service provided by the digital component distribution system 150. In these situations, the digital component script is executed by the client device 110 when the given electronic document is processed by the client device 110. Execution of the digital component script configures the client device 110 to generate a request for digital components (referred to as a “component request”), which is transmitted over the network 105 to the digital component distribution system 150. For example, the digital component script can enable the client device 110 to generate a packetized data request including a header and payload data. The component request is transmitted, by the client device 110, over the network 105 to a server of the digital component distribution system 150.

The digital component distribution system 150 selects digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script) in response to receiving the component request and/or using information included in the component request.

In some implementations, a digital component is selected in less than a second to avoid errors that could be caused by delayed selection of the digital component. For example, delays in providing digital components in response to a component request can result in page load errors at the client device 110 or cause portions of the electronic document to remain unpopulated even after other portions of the electronic document are presented at the client device 110.

Also, as the delay in providing the digital component to the client device 110 increases, it is more likely that the electronic document will no longer be presented at the client device 110 when the digital component is delivered to the client device 110, thereby negatively impacting a user's experience with the electronic document. Further, delays in providing the digital component can result in a failed delivery of the digital component, for example, if the electronic document is no longer presented at the client device 110 when the digital component is provided.

The client device 110 can report events related to the presentation of digital components to the network measurement system 120. For example, digital components can include data, e.g., scripts, that instruct the client device 110 to send event data to the network measurement system 120. The event data can include, for example, data identifying a digital component presented by the client device 110, whether the user interacted with, e.g., selected, the digital component, the resource (e.g., electronic document) with which the digital component was presented, whether a conversion occurred after the user viewed or interacted with the digital component, and/or other information related to the presentation and/or user interaction with a digital component.

In some implementations, the digital component distribution system 150 can report event data for digital components to the network measurement system 120. For example, this event data can include the same event data as the client device 110 and/or other event data, e.g., conversion data that indicates whether a user of a client device 110 performed a specified action after viewing or interacting with a digital component. The specified action can include, for example, registering for a newsletter, signing up for an event, purchasing an item (e.g., product or service), adding an item to a virtual shopping cart, downloading an application (e.g., a mobile app), etc.

The network measurement system 120, which can be implemented as one or more computers in one or more locations, can store the event data in a network data storage device 122. The network data storage device 122 can include a data structure, e.g., a database, that stores the event data received from multiple client devices 110.

The network measurement system 120 can use the event data to generate network measurement data for the digital components. As described above, the network measurement data can include data related to presentations, user interactions, conversions, and/or other events related to digital components. The network measurement data can include presentation counts for digital components (e.g., the number of times a digital component has been presented), the number of unique users to which each digital component has been presented, the number of user interactions with each digital component, the rate at which users interact with each digital component, the number of times a specific action occurs after a digital component is presented or receives a user interaction (e.g., conversion rate), and/or a rate at which the specified action occurs following presentations of and/or user interactions with a digital component. To protect the security of such data and to preserve the privacy of user data used to generate such measurements, the network measurement system can generate noise that can be applied to the event data and/or network measurement data prior to the network measurement data being sent to a recipient. In this way, when the data is provided to recipients, the recipients cannot identify events or data related to particular users or learn other information about the particular users.

Although the examples described in this document relate to digital components, the differential privacy techniques described herein can be used to generate differentially private data for any other use case. For example, the techniques can be used to add differential privacy noise to demographic information, medical information, statistical information for a dataset, and/or other types of sensitive data of people or other types of datasets for other types of items.

The network measurement system 120 includes a data manager 124 and a query handler 126, both of which can be implemented using one or more computers in one or more locations. The data manager 124 can receive the event data from the client devices 110 and/or the digital component distribution system 150 and store the data in the network data storage device 122. The data manager 124 can also interact with the noise generator(s) 130 to generate differential privacy noise for data of the dataset.

In some implementations, the data manager 124 can interact with one noise generator 130 to generate differential privacy noise to apply to data of a dataset. In such examples, the noise generator 130 can generate the noise, e.g., by generating a distribution and sampling from the distribution, and provide the noise to the data manager 124. The data manager 124 can apply the noise to the data of the dataset, e.g., by adding the noise to data of the dataset. For example, if the data is a number and the noise is a number, e.g., an integer, the data manager 124 can add the noise to the data.

In some implementations, the data manager 124 can interact with multiple noise generators 130 to generate differential privacy noise for the data. In one such example, the data manager 124 can provide a respective share (e.g., a respective secret share) of the data to each of the multiple noise generators 130. Each noise generator 130 can generate noise for its share of the data, apply the noise to the share of the data, e.g., by adding the noise to the share of the data, and provide the noised share of the data to the data manager 124. The data manager 124 can then combine the noised shares, e.g., by determining a sum of the noised shares, to generate the noised data that satisfies differential privacy, e.g., based on differential privacy parameters epsilon (ε) and delta (δ). The parameter (ε) is a metric of privacy loss (which can control the level of privacy of a DP mechanism) and the parameter & is a probability of privacy leakage.

In examples that use secret shares, the noise generators 130 can execute a secure multi-party computation (MPC) protocol to generate the noise using secret shares of the data. For example, the data manager 124 can use the secure MPC protocol to generate secret shares of the data and send the secret shares of the data to the noise generators 130. Each noise generator 130 can execute the secure MPC protocol to generate noised data using a noise distribution described in this document.

In another example, each noise generator 130 can generate a share of the noise and provide the share of the noise to the data manager 124. In this example, the data manager 124 can determine the total noise, e.g., by determining a sum of the shares of the noise and apply the total noise to the data of the dataset to be sent in response to a query or request, e.g., by determining a sum of the data and the total noise.

The query handler 126 receives queries for network data, e.g., network measurement data based on the network data, and provides data that satisfies the queries to recipients. For example, the digital component distribution system 150 can send queries for network measurement data for digital components or groups of digital components (e.g., digital components for a same subject). Each query can specify criteria for the data, e.g., the type of measurement and the digital component(s) for which measurement data is requested. For example, a query can request the number of unique viewers to which a particular digital component was presented. The query can indicate the digital component or group of digital components using an identifier for the digital component or group of digital components.

The data manager 124 can interact with the noise generator(s) 130 to generate differentially private data for the query handler 126 to provide in response to queries. In some implementations, the data manager 124 can interact with the noise generator(s) 130 to generate the differentially private data at query time (e.g., in response to receiving a query) or in advance, e.g., periodically based on a specified time period, in response to a request to generate noised data, prior to accepting queries, or otherwise prior to receiving a query for the data.

The noise generators 130 can be configured to generate and sample noise using a multi-scale discrete Laplace mechanism, a generalized discrete Laplace mechanism, a continuous transformed multi-scale discrete Laplace mechanism, or a continuous transformed generated discrete Laplace mechanism. Each of these mechanisms can be used to generate noise distributions that are infinitely divisible. A probability distribution D is infinitely divisible if, for every positive integer n, there exists n independent and identically distributed random variables Z₁, . . . , Zₙ~D_{/n} such that their sum Z=Σᵢ₌₁ⁿZᵢ is distributed as D. In differential privacy, n parties can sample Zᵢ such that the sum is distributed according to D, which can be shown to protect the dataset with differential privacy. The infinite divisibility property of D allows for distributed protocols where an arbitrary n≥1 number of parties (e.g., number of noise generators 130) can participate in generating the noise. Under the more restrictive setting where the additive noise mechanism M must sample the noise Z from an infinitely divisible distribution, the various mechanisms described in this document can match the optimal MSE of the staircase mechanism that is known to have optimal (in ε) MSE of O(Δ₃e^{-ε}) in the discrete setting and

$$O ( {Δ}^{2} {e}^{\frac{- 2 ε}{3}} )$$

in the continuous setting. For the purposes of this document, a discrete setting refers to a distribution of discrete values, e.g., integer values, and a continuous setting refers to a distribution of continuous values, e.g., real number values.

### Example Noise Distributions and Associated Mechanisms

In the following discussion of example noise distributions, the following notations are used for the probability mass functions (PMFs). For a discrete distribution D with support on X, the PMF is denoted as ƒ_{D}(k) for k∈X. When it said that a discrete distribution is infinitely divisible, it can be assumed implicitly that D_{/n} are also discrete. For a continuous distribution D on [symbol] , the PMF is denoted as ƒ_{D}(k) for x∈ [symbol] .

The following observations can also be made. If a random variable Z is infinitely divisible, then c·Z is infinitely divisible for any constant c. If random variables Z₁, Z₂ are infinitely divisible, then Z₁+Z₂ is also infinitely divisible.

A distribution D is closed under summation if D is infinitely divisible and additionally, the n-th root of D (denoted D_{/n}) follows the same distribution as D for all n∈ [symbol] . This additional property provides benefits in the distributed setting as it ensures that the mechanism's privacy is well-understood even as parties unexpectedly drop out or join the protocol.

Let D_{∞}(P∥Q) denote the maximum divergence between two distributions P, Q, i.e.,

$${max}_{x ∈ supp ( P )} \frac{{f}_{P} ( x )}{{f}_{Q} ( x )} .$$

Two properties of the maximum divergence D_{∞}(·∥·) are used below. One, for any (possibly randomized) function ƒ and any random variables U, V, one has: D_{∞}(ƒ(U)∥ƒ(V))≤D_{∞}(U∥V). In another, for any distributions P, Q, R, one has: D_{∞}(P∥Q)≤D_{∞}(P∥R)+D_{∞}(R∥Q).

For a given query function q:X^{d}→y, it can be said that Δ(q)=max_{x,x′}|q(x)−q(x′)|, where the maximum over all pairs x and x′ differing on one entry. The D-noise addition mechanism for a query function q is the mechanism M(x) that outputs q(x)+Z, where the noise Z is drawn from the distribution D. For a discrete distribution D, it can be said that the D-noise addition mechanism is ε-DP for sensitivity Δ if the D-noise addition mechanism is ε-DP for all queries q:X^{d}→ [symbol] (resp. q:X^{d}→

$$O ( {Δ}^{2} {e}^{\frac{- 2 ε}{3}} )$$

for continuous distributions such that Δ(q)≤Δ. Similarly, for a continuous distribution D, it can be said that the D-noise addition mechanism is ε-DP for sensitivity Δ if the D-noise addition mechanism is ε-DP for all queries q:X^{d}→

$$O ( {Δ}^{2} {e}^{\frac{- 2 ε}{3}} )$$

such that Δ(q)≤Δ. It follows that the definition of DP and max divergence that this condition translates to: for a discrete distribution D, the D-noise addition mechanism is ε-DP for sensitivity Δ if: D_{∞}(D+ξ∥D)≤ε for all ξ∈{−Δ, −(Δ−1), . . . , Δ} for discrete distributions or D_{∞}(D+ξ∥D)≤ε for all ξ∈{−Δ, Δ} for continuous distributions.

One example noise distribution mechanism is the generalized discrete Laplace (GDL) mechanism. In this mechanism, GDL(β, α) denotes the distribution of Z₁-Z₂ for β, α>0, where Z₁, Z₂~N_{B}(β, 1−e^{-α}) are independent, and where NB is a negative binomial distribution. Here, β can be the first parameter of the NB, e.g., the number of successes parameter, and a can be used to derive the second parameter of the NB, e.g., the probability of success parameter.

The PMF of GDL(β, α), i.e., ƒ_{GDL(β,α)}(x), is shown in Equation (1) below:

$$GDL ( β , α ) = {{e}^{- a \vert x \vert} ( 1 - {e}^{- a} )}^{2 β} {}_{2} {F}_{1} [ β ; β + \vert x \vert ; 1 + \vert x \vert ; {e}^{- 2 a} ] \frac{Γ ( β + \vert x \vert )}{Γ ( 1 + \vert x \vert ) Γ ( β )}$$

for all x ∈

[symbol]

This discrete Laplace distribution is a special case of the GDL with β=1, as the

$$PMF {f}_{GDL ( 1 , a )} ( k ) = {f}_{DLap ( a )} ( k ) = tanh ( \frac{a}{2} ) {e}^{- a \vert k \vert} .$$

The infinite divisibility of the binomial distribution immediately implies that GDL is also infinitely divisible. For example, the GDL distribution is infinitely divisible and closed under summation. In particular, for independent random variables:

$${X}_{1} ∼ GDL ( {β}_{1} , a ) , … , {X}_{n} ∼ GDL ( {β}_{n} , a ) , one has X = {\sum }_{i = 1}^{n} {X}_{1} ∼ GDL ( {\sum }_{i = 1}^{n} {β}_{1} , a )$$

The following are some characteristics of the discrete Laplace distribution. One characteristic is that, for

$$0 < β < 1 , {f}_{GDL ( β , a )}^{ℝ} ( x )$$

is decreasing and log convex on [0, ∞].

Another characteristic of the discrete Laplace distribution: let ƒ(x) be symmetric about 0 and decreasing and log convex on [0, ∞]. Then, for any x, x′ such that |x−x′|≤Δ,

$$\frac{f ( x )}{f ( {x}^{′} )} \leq \frac{f ( 0 )}{f ( Δ )} .$$

The privacy guarantee of the GDL noise addition mechanism can be expressed as follows. For any Δ∈ [symbol] , β, α>0, the GDL(β, α)-noise addition mechanism is ε-DP for sensitivity if and only if:

$$ε \leq \{ \begin{matrix}a Δ + log \frac{{}_{2} {F}_{1 [ β ; β ; 1 ; {e}^{- 2 a} ]}}{{}_{2} {F}_{1 [ β ; β + Δ ; 1 + Δ ; {e}^{- 2 a} ]}} \\ \begin{matrix}a Δ & β \geq 1\end{matrix}\end{matrix} \begin{matrix}\frac{Γ ( Δ + 1 ) Γ ( β )}{Γ ( β + Δ} & 0 < β < 1\end{matrix}$$

Another characteristic of the discrete Laplace distribution is that, for any Δ∈N, α>0, β∈(0,1), the GDL(β, α)-noise addition mechanism is ε-DP for sensitivity Δ where

$$ε \leq a Δ + log ( \frac{Δ}{β} ) .$$

The discrete Laplace distribution mechanism is ε-DP for all

$$ε \leq a Δ + log ( \frac{Γ ( Δ + 1 ) Γ ( β )}{Γ ( β + Δ )} ) .$$

For any

$$Δ ∈ N and ε > 2 + log Δ , the GDL ( {Δe}^{2 - ε )} , \frac{2}{Δ} )$$

-noise addition mechanism is ε-DP for sensitivity Δ and has a MSE of O(Δ³e^{-ε}).

Another example noise addition mechanism is the multi-scale discrete Laplace noise addition mechanism, which can be denoted as the (ε, Δ)-multi-scale discrete Laplace or ((ε, Δ)-MSDLap) distribution. This distribution with parameter ε>0, Δ∈ [symbol] is defined as the distribution of τᵢ₌₁^{Δ}i·Xᵢ, where X₁, . . . , X_{Δ}~DLAP(ε) are independent. Recall the observations that, if a random variable Z is infinitely divisible, then c·Z is infinitely divisible for any constant c and that, if random variables Z₁, Z₂ are infinitely divisible, then Z₁+Z₂ is also infinitely divisible. From these observations, the (ε, Δ)-MSDLap distribution is infinitely divisible.

The (ε, Δ)-MSDLap noise additional mechanism has the following characteristics. One characteristic is that, for any ε>0, Δ∈ [symbol] , the (ε, Δ)-MSDLap noise addition mechanism is ε-DP for sensitivity Δ. Furthermore, for ε≥1, the MSE is O(Δ³e^{-ε}).

For a fixed sensitivity Δ, the ratio of the MSE of the (ε, Δ)-MSDLap noise addition mechanism and that of the ε-DP discrete stair mechanism for sensitivity Δ approaches 1 as ε→∞.

For any ε≥2, Δ∈ [symbol] and every r∈{0, . . . , Δ}, there exists an infinitely divisible noise-addition mechanism that is ε-DP for sensitivity Δ and has MSE of

$$O ( {r}^{2} + \frac{{e}^{- ε} {Δ}^{3}}{r + 1} ) .$$

It should be noted that, by plugging in r=0, r=┌e^{-ε}/3Δ┐, the following corollary is obtained. For any ε≥2 and every rε{0, . . . , Δ}, there exists an infinitely divisible discrete noise-addition mechanism that is ε-DP for sensitivity Δ with MSE of

$$O ( {Δ}^{2} min \{ {e}^{- 3} Δ , {e}^{- 2 ε / 3} \} ) .$$

The discrete mechanisms described above for integer-valued functions can be transformed to real-valued functions using the following techniques. These techniques are similar to the (ε, Δ)-MSDLap noise additional mechanism where, for any ε≥2, Δ∈ [symbol] and every r∈{0, . . . , Δ}, there exists an infinitely divisible noise-addition mechanism that is ε-DP for sensitivity Δ and has MSE of

$$O ( {r}^{2} + \frac{{e}^{- ε} {Δ}^{3}}{r + 1} ) .$$

However, a continuous Laplace noise is used to smoothen out the holes instead of its discrete analog described above.

For ε≥2 and Δ>0, there exists a continuous infinitely divisible noise-addition mechanism that is ε-DP for sensitivity Δ and has MSE of O(Δ²·e^{-2ε}/3). Since the input can be scaled by 1/Δ and noise can be added and scaled back, it can be assumed without loss of generality that

$$Δ = 1. Let {ε}_{d} = ε - 1 , {Δ}_{d} = ⌈ {e}^{ε / 3} ⌉ and r = \frac{1}{{Δ}_{d}} .$$

Let D_{d} be an infinitely divisible discrete distribution such that the D_{d}-noise addition mechanism is ε_{d}-DP for sensitivity Δ_{d} with MSE of O(Δ_{d}³·e^{-ε}^{_{d}}).

Let D be the distribution of Z=r·X+Y where X~D_{d} and Y~Lap(r/2) are independent. Since both X, Y are infinitely divisible, the observations made above imply that D is also infinitely divisible.

This can be used to transform the discrete Laplace mechanism to a continuous transformed generalized discrete Laplace mechanism as well as to transform the multi-scale discrete Laplace mechanism to a continuous transformed multi-scale discrete Laplace. This results in continuous distributions of real numbers in place of the distributions of integers.

### Example Sampling Mechanisms

The following mechanisms can be used to efficiently sample noise from the noise distributions described above. In distributed processes, each party, e.g., each noise generator 130, can independently sample noise from a distribution that is independently generated by that party.

Recall that the (ε, Δ)-MSDLap noise is defined as Σᵢ₌₁^{Δ}i·Xᵢ, where X₁, . . . , X_{Δ}~DLAP(ε)=NB(1,1−e^{-ε}) are independent. In other words, each of the n parties can sample Σᵢ₌₁^{Δ}i·(Uᵢ−Vᵢ), where

$${U}_{1} , … , {U}_{Δ} , {V}_{1} , … , {V}_{Δ} ∼ NB ( \frac{1}{n} , 1 - {e}^{- ε} ) .$$

Thus, a naive algorithm may require that each party sample from k=2Δ negative binomial random variables. For large sensitivity Δ, or for Δ=O(ε/3), this would likely be very computationally expensive. The following techniques for sampling noise significantly reduces the computational burden of the sampling, enabling the noise generators 120 to sample from exponentially many (in ε) negative binomial random variables in expected constant time.

For example, let ε>1 and p be a rational upper bound for 1−e^{-ε}. Sampling procedure 3 described below can sample from

$$k = O ( \frac{{e}^{ε}}{r} )$$

independent and identically distributed NB(r, p) random variables using O(1) arithmetic steps in expectation. The approach leverages the fact that these negative binomial random variables will be 0. The problem of sampling many negative binomials can be reframed as into two separate problems: sampling from the sum of many independent and identically distributed negative binomials and fairly allocating the result across each random variable.

While sampling from the sum of many negative binomials is simple on its face given their infinite divisibility, standard exact samplers for NB(r, p) take time linear in r which is not desirable. In sampling procedure 1 described below, the (expected) running time only scales with the mean of NB(r, p), which is only O(r·e^{-ε}) in this setting.

To fairly allocate across the random variables, the fact that the conditional distribution of the sequence of NB random variables given their sum follows the Dirichlet multinomial distribution, denoted DirM(n, α), is leveraged. Given α={α₁, . . . αₖ} and α₀=Σᵢ₌₁^{k}α,

$${f}_{D i rM ( n , α )} ( x ) = \frac{Γ ( {α}_{0} ) Γ ( n + 1 )}{Γ ( n + {α}_{0} )} {\prod }_{i = 1}^{k} \frac{Γ ( {x}_{i} + {α}_{i}}{Γ ( {α}_{i} ) Γ ( {x}_{i} + 1 )}$$

Let X={X₁, . . . , Xₖ} be a vector of independent entries where each Xᵢ~NB(αᵢ, p). Let T=Σᵢ₌₁^{k}Xᵢ. Then, the conditional distribution X|T~DirM(T, α).

The samplers can be implemented on a finite computer, e.g., in the Word RAM model, avoiding any real-arithmetic operations. The expected number of arithmetic operations would take only polynomial time in the bit complexity of the parameters.

The sampling procedures can include (1) sampling from the negative binomial distribution with sampling procedure 1 to learn the sum of all the terms, handling rational values of r using a simple rejection sampler and (2) sampling from the Dirichlet multinomial distribution with sampling procedure 2, which uses a version of the Polya urn process modified to handle rational fractions of balls. The output can be sparsely encoded to avoid storing zero entries, as MSDLAP sampling only involves summing non-zero random variables.

Sampling procedure 1 involves a negative binomial sampling optimized for p>1/2, and can include the following steps:
Input: r∈ [symbol] , 0<p<1ε [symbol]
Output: A sample from NB(r,p), where NB is a negative binomial distribution
first loop
   Sample w←SampleIntegerNB([r], p)

$${A}_{w} ← \frac{{( r )}_{w}}{{( ⌈ r ⌉ )}_{w}}$$

Sample accept←Ber(A_{w})
if accept then return w
procedure SampleIntegerNB([r], p)
   failures←0
successes←0
   second loop
   Sample s←Geo(1−p)
   successes←successes+s
   if successes≥r then
      return failures
   failures←failures+1

This sampling procedure is designed to efficiently and exactly sample a random variable from a negative binomial distribution NB(r,p). This procedure is optimized for the spare regime where the success probability p is greater than ½ or, specifically, where the expected value if less than r.

The first loop is a rejection sampler proposing NB([r], p), where [r] is the ceiling function applied to r to round r up to the nearest integer. This part uses a rejection sampling method to handle non-integer values of the stopping parameter r. It relied on the fact that the NB(r,p) distribution can be sampled by proposing a sample from NB([r], p) can accepting it with a specific probability. The procedure continuously loops and proposes a sample, w, from the integer-parameter negative binomial distribution NB([r], p). This is done by calling the SampleIntegerNB procedure.

The first loop also calculates the acceptance probability, A_{w}, based on the proposed sample, w, and the parameters r and [r]. It draws a random variable, accept, from a Bernoulli distribution with success probability A_{w}, i.e., Ber(A_{w}). If the proposal is accepted, (if accept is true), the sample, w, is returned. If rejected, the first loop continues to propose another sample.

The SampleIntegerNB procedure is a streamlined technique to sample from NB(r,p) when r is an integer. The negative binomial distribution models the number of failures (output) before observing r successes (stopping criteria) in a sequence of Benoulli trials. This procedure efficiently counts failures by batching successes using a geometric distribution. The parameters failures and successes are initialized to zero. In a second loop, it samples s a geometric distribution Geo(1−p) that models the number of successes before the first failure in a sequence of Bernoulli trials with success probability 1−p. The NB(r,p) mechanism, however, is typically defined with success probability p, so Geo(1−p) models the number of failures before a first success. For each successful batch of successes, the procedure increments the count of failures by 1. The count of successes is updated by the sampled batch size s. If the total number of accumulated successes is greater than or equal to r, the procedure is completed r successes and returns the final count of failures.

Sampling procedure 2 includes sparse Dirichlet multinomial sampling, which is an exact sampling procedure used to fairly allocate a total count (the sum of many negative binomial random variables) back across the individual variables. This increases the efficiency of the sampling procedure 3 because it handles the sparse nature of the high-ε regime where most individual samples are zero. This sampling procedure models the process of sampling from the Dirichlet multinomial distribution, DirM*(n, {α, . . . , α}), where n is the total count, k is the number of variables, and α is a rational parameter

$$α = \frac{a}{b} .$$

Sampling procedure 2 includes the following steps:

$$Input : n ∈ ℕ , k ∈ ℕ , α = \frac{a}{b} ∈ ℚ$$

Output: A sample from DirM*(n, {α, . . . , α}), encoded as a sparse map from variate index to count, with zero variates removed.

```
picked ← [symbol]  (vector data structure)
initialsize ← k · a
for i from 0 to n − 1, do
  urnsize ← initialsize + i · b
  Sample U ∈ {1, ... , urnsize} uniformly at random
  if U < initialsize then
    $idx ← ⌈ \frac{U}{a} ⌉$
    Append idx to picked
  Else
    $idx ← ⌈ \frac{( U - initialsize )}{b} ⌉$
    Append picked[idx] to picked
counter ← { }
for p in picked do
  if p in counter then
    counter[p] ← counter[p] + 1
  else
    counter[p] ← 1
return counter
```

The inputs include n, which is the total number of items to be allocated (the sum T from sampling procedure 3), k, which is the number of independent binomial random variables, and

$$α = \frac{a}{b} ,$$

which corresponds to r in the negative binomial context. The output is a sparse map where the key is the index of the variable and the value is the final count, with cero counts removed.

The core of sampling procedure 2 is to simulate a Polya urn model over n steps. The first two steps initialize the urn to contain a balls for each of the k colors. The total number of balls in the urn initially, initialize, is set to k·α.

The procedure loops n times, corresponding to the total count T from sampling procedure 3. The size of the urn, urnsize, is updated at each step i. The factor b accounts for the fractional component of α. A ball, U, is chosen uniformly at random from the current urnsize.

If U<initialize, the ball came from one of the original k·α balls. The index, idx, of the selected color is calculated as

$$⌈ \frac{U}{a} ⌉ .$$

This index is appended to the picked vector.

If U≥initialize, the ball came from one of the replacement balls. The index, idx, is calculated based on which block of b replacement balls the value U fell into:

$$⌈ \frac{( U - initialsize )}{b} ⌉ .$$

The color of the ball is not idx, but the color that was picked previously at that index in the picked vector: picked[idx].

The selected ball is implicitly replaced, along with b other balls of the same color in the next iteration's urnsize calculation: urnsize←initialsize+i·b

After the n draws, the picked vector contains the sequence of n colors (indices) that were selected. A map, counter, is used to tally the occurrences of each unique index in the picked vector. The counter map is returned. This map represents the final allocation X={x₁, . . . , xₖ} as a sparse encoding, which is efficient because it avoids storing the indices that were never picked (count of 0).

Sampling procedure 3 includes sparse multivariate independent and identically distributed NB sampling, and provides an overall procedure designed for efficiently and exactly sampling from k independent and identically distributed negative binomial distributions NB(r,p), and is tuned for the high-ε (sparse) regime where most samples are zero. Sampling procedure 3 combines two core ideas: (1) sampling the total sum using the infinite divisibility property of the negative binomial distribution and (2) fairly allocating this sum back to the individual variables using the properties of the Dirichlet multinomial distribution.

Sampling procedure 3 can include the following steps:
Input: k, r∈ [symbol] , 0<p<1∈ [symbol]
Output: Non-zero samples X₁, . . . , Xₖ where Xᵢ~NB(r, p)
Sample T←NB(k·r,p)—Use sampling procedure 1
Sample counter←DirM(T,k,r)—Use sampling procedure 2
Return counter

This sampling procedure 3 calls sampling procedures 1 and 2 to reduce the latency in sampling noise by obtaining multiple samples at once. For example, sampling procedure 1 is called in the first step using parameters (k·r, p) and procedure 2 is called in the second step using parameters (T,k,r).

The sampling procedures shown above have the following characteristics. For input r∈ [symbol] and, 0<p<1∈ [symbol] , procedure 1 returns one sample from NB(r,p) and completes in

$$O ( \frac{1}{p} + \frac{r ( 1 - p )}{{p}^{2}} )$$

arithmetic operations in expectation.

The first sampling procedure calculates the total sum of k independent and identically distributed negative binomial distributions NB(r,p), which is itself an NB(k·r, p) variable. T represents the total number of items to be allocated among the k variables. The second sampling procedure allocates the sum sparsely. The conditional distribution of the vector of individual samples, X={x₁, . . . , xₖ} given their sum T follows the Dirichlet multinomial distribution DirM(T, {r, . . . , r}). This step uses sampling procedure 2 to allocate the total sum T across the k variables. The output, counter, is a sparse map containing only the non-zero counts. The sparse map counter provides the non-zero samples X={x₁, . . . , xₖ} as desired.

For input n, k∈ [symbol] , and α∈ [symbol] , sampling procedure 2 returns one sample from DirM(n, {α, . . . , α}) and involves only O(n) arithmetic operations in expectation.

For input k, r∈ [symbol] , and p∈ [symbol] , sampling procedure 3 returns non-zero samples from k independent and identically distributed samples of NB(r,p) and completes in

$$O ( \frac{1}{p} + \frac{k \cdot r ( 1 - p )}{{p}^{2}} )$$

steps in expectation.

Although the sampling procedures shown and described above are adapted for distributed noise generation, they can also be used in non-distributed central models, e.g., a single party computing a large number of discrete Laplace random variables. In this case, r=1 and O(e^{ε}) discrete Laplace random variables can be computed in constant expected time.

The following description shows how the procedures above can be adapted to the different noise addition mechanisms described above. Recall the following notations from above:
n: the number of parties that generate noise,
Zⱼ: the noise drawn by party j,
Z: the total noise (i.e., Z=Z₁+ . . . +Zₙ).

A distributed sampler for (ε, Δ)-multi-scale discrete Laplace distribution can be implemented as follows:

For i in 1, . . . , Δ:
Sample Uⁱⱼ~NB(1/n, 1−e^{-∈})
Sample Vⁱⱼ~NB(1/n, 1−e^{-∈})
Output Zⱼ=Σᵢ₌₁^{Δ}i·(Uⁱⱼ−Vⁱⱼ)

In this sampler, the negative binomial sampler from sampling procedure 1 or sampling procedure 3 above can be used to generate the Uⁱⱼ, Vⁱⱼ for the steps above using the parameters in parenthesis. That is, the notation NB represents a call to either sampling procedure 1 or sampling procedure 3 using the parameters in parenthesis. For example, the sample UL can be generated by calling sampling procedure 1 or 3 using parameter 1/n as the first parameter of the negative binomial distribution and parameter 1−e^{-ε} as the second parameter of the negative binomial distribution.

In this sampler, each noise generator j obtains multiple subsamples for each of multiple scales i from 1 to Δ. Each scale i can be an integer from 1 to Δ. In this example, there are two subsamples U and V. Each noise generator j then generates its share or the noise as output Zⱼ by determining a sum of the difference between subsamples U and V for each scale i.

A distributed sampler for generalized discrete Laplace GDL (β, α) can be implemented as follows:
Sample Uⱼ~NB(β/n, 1−e^{-α})
Sample Vⱼ~NB(β/n, 1−e^{-α})
Output Zⱼ=Uⱼ−Vⱼ

In this sampler, the negative binomial sampler from sampling procedure 1 or sampling procedure 3 above can be used to generate the Uⁱⱼ, Vⁱⱼ for the steps above. As described above, the notation NB can represent a call to one of these sampling procedures using the parameters in parenthesis. Here, a ratio between a scaling factor β and the number n of noise generators is the number of successes parameter for the negative binomial distribution and 1−e^{-ε} is the success probability parameter for the negative binomial distribution. Typically, the scaling factor β is a value that is less than one. The scaling factor β can be determined based on the desired level of privacy.

A distributed sampler for the continuous transform of the multi-scale discrete Laplace distribution can be implemented as follows:
Sample Wⱼ~Γ(1/n, r/2)
Sample Rⱼ~Γ(1/n, r/2)

The following steps of this sampler can be replaced by the distributed sampler of a different distribution if we use the continuous transform on that distribution (instead of MSDLap):

For i in 1, . . . , Δ_{d}:
Sample Uⁱⱼ~NB(1/n, 1−e^{-∈}^{_{d}})
Sample Vⁱⱼ~NB(1/n, 1−e^{-∈}^{_{d}})
Output Zⱼ=(Wⱼ−Rⱼ)+r·Σᵢ₌₁^{Δ}^{_{d}}i·(Uⁱⱼ−Vⁱⱼ)

In this sampler, the negative binomial sampler from sampling procedure 1 or sampling procedure 3 above can be used to generate the Uⁱⱼ, Vⁱⱼ for the steps above. In addition to the steps of the discrete MSDLap, this sampler obtains subsamples Wⱼ and Rⱼ from gamma distribution Γ(1/n, r/2). The sampler determines the share of the noise (Output Zⱼ) using the difference between the subsamples of the gamma distribution and the sum of the differences of the subsamples of the negative binomial distribution for each scale i.

A distributed sampler for the continuous transform of the generalized discrete Laplace can be implemented as follows:
Sample Wⱼ~Γ(1/n, r/2)
Sample Rⱼ~Γ(1/n, r/2)
Sample Uⱼ~NB(Δ_{d}e^{2-∈}^{_{d}}/n, 1−e^{-2/Δ}^{_{d}})
Sample Vⱼ~NB(Δ_{d} e^{2-∈}^{_{d}}/n, 1−e^{-2/Δ}^{_{d}})
Output Zⱼ=(Wⱼ−Rⱼ)+r·(Uⱼ−Vⱼ)

In this sampler, the negative binomial sampler from sampling procedure 1 or sampling procedure 3 above can be used to generate the Uⁱⱼ, Vⁱⱼ for the steps above. In addition to these subsamples, the sampler obtains subsamples from gamma distribution Γ(1/n, r/2) for use in determining the share of the noise Output Zⱼ.

The following tables show some of the characteristics of the noise techniques described herein as compared to other noise generation techniques. The characteristics include the mean square error (MSE) and whether the distributions are infinitely divisible.

TABLE 1
Discrete Distributions

| Distribution | MSE | Infinitely Divisible |
|---|---|---|
| Discrete Laplace | e^{-ε/Δ} | Yes |
| Discrete Staircase | min{Δ³e^{-ε}, Δ²e^{-2ε/3}} | No |
| Generalized Discrete Laplace (GDL) | Δ³e^{-ε} for sufficiently | Ye |
| | large ε | |
| Multi-Scale Discrete Laplace (MSDLap) | min{Δ³e^{-ε}, Δ²e^{-2ε/3}} | No |

TABLE 2
Continuous Distributions

| Distribution | MSE | Infinitely Divisible |
|---|---|---|
| Laplace | Δ²e² | Yes |
| Staircase | Δ²e^{-2ε/3} | No |
| Arete | Δ²e^{-ε/4} | Ye |
| Continuous MSDLap | Δ²e^{-2ε/3} | No |

Example noise distributions and techniques for generating and sampling from the noise distributions that can be used in accordance with the systems and techniques described in this document are described in “Infinitely Divisible Noise for Differential Privacy: Nearly Optimal Error in the High ε Regime,” by Charlie Harrison et al., published Apr. 8, 2025, which is hereby incorporated herein by reference in its entirety.

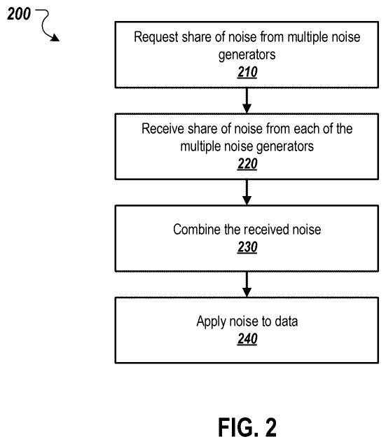

FIG. 2 is a flow diagram of an example process 200 for generating differential privacy noise. Operations of the process 200 can be performed, for example, by the network measurement system 120 of FIG. 1. The operations of the process 200 can also be implemented as instructions stored on a computer readable medium, which can be non-transitory. Execution of the instructions, by one or more data processing apparatus, causes the one or more data processing apparatus to perform operations of the process 200. For brevity, some operations of the process 200 are described as being performed by a system. The system can be the network management system 120, or another appropriate system.

The system requests a share of noise from multiple noise generators (210). For example, the system can send a request to each of the multiple noise generators, e.g., the noise generators 130 of FIG. 1. The request can include the differential privacy parameters epsilon (ε) and delta (δ) and the number of parties participating in the noise generation protocol n. For the continuous transform mechanisms, the request can also include the parameters ∈_{d}, Δ_{d}, and r.

In some implementations, the system can send the request with a share of the data to which the noise should be added. In this example, each noise generator can apply its generated noise to its share of the data.

The system receives a share of noise from each of the multiple noise generators (220). Each noise generator can generate its share of the noise by generating a noise distribution and sampling the noise distribution using one of the noise addition mechanisms described above. For example, each noise generator can use the same noise addition mechanisms, such as a multi-scale discrete Laplace mechanism, a generalized discrete Laplace mechanism, a continuous transformed multi-scale discrete Laplace mechanism, or a continuous transformed generated discrete Laplace mechanism.

The system combines the shares of the noise (230). In some implementations, the system can combine the shares of the noise by adding the shares together. The system can combine the shares of the noise to generate total noise to be added to data to make the data differentially private.

In implementations in which the noise generators generate shares of noised data, the system can combine the shares of the noised data to arrive at the differentially private data.

The system applies the shares of the noise to the data (240). In some implementations, the system applies the noise to the data by adding the noise to the data. For example, if the data is a number and the noise is a number (e.g., an integer in a discrete mechanism or a real number in a continuous mechanism), the system can add the value of the noise to the data. The system can then send the noised data to a recipient, e.g., an entity that requested the data.

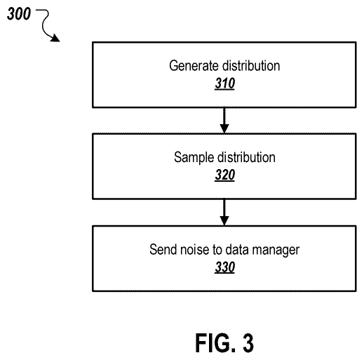

FIG. 3 is a flow diagram of an example process 300 for generating differential privacy noise. Operations of the process 300 can be performed, for example, by a noise generator 130 of FIG. 1. The operations of the process 300 can also be implemented as instructions stored on a computer readable medium, which can be non-transitory. Execution of the instructions, by one or more data processing apparatus, causes the one or more data processing apparatus to perform operations of the process 300. For brevity, some operations of the process 300 are described as being performed by a system. The system can be a noise generator 130, or another appropriate system.

The system generates a noise distribution (310). The system can generate any one of the noise distributions described above. For example, the system can generate a noise distribution using any one of the noise addition mechanisms described above, e.g., the multi-scale discrete Laplace mechanism, the generalized discrete Laplace mechanism, the continuous transformed multi-scale discrete Laplace mechanism, or the continuous transformed generated discrete Laplace mechanism.

The system samples the distribution (320). Depending on the distribution, the system can use one of the sampling mechanisms described above.

The system sends the noise to a data manager (330). For example, the system can send the noise to the data manager 124 of the network measurement system 120 of FIG. 1. The data manager can combine the noise from multiple noise generators and apply the noise to data, as described above with reference to FIG. 2.

In some implementations, the system can apply the sampled noise to a share of data received from the data manager. For example, the system can add the noise to the share of the data. The system can then send the noised share of the data to the data manager. In this example, the data manager can combine shares of noised data received from multiple noise generators to arrive at the differentially private data.

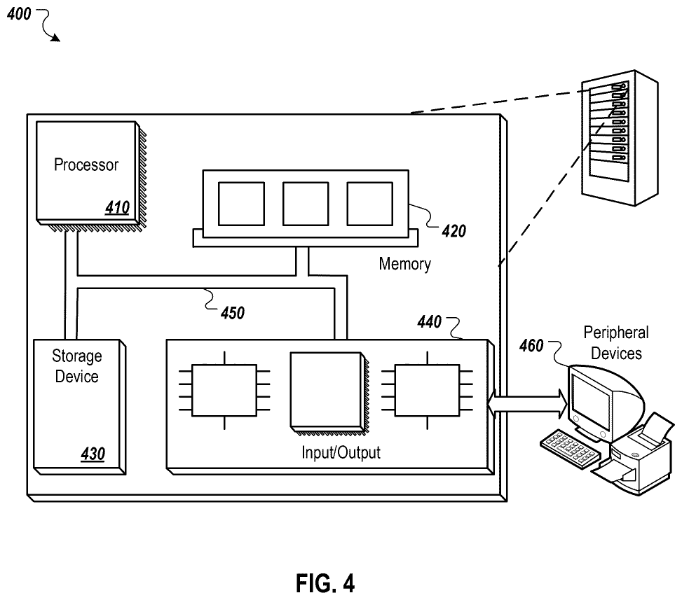

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface device, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
sending, to each noise generator or multiple noise generators, noise generation data comprising differential privacy parameters and a number of noise generators that are generating shares of differential privacy parameters;
receiving, from two or more of the noise generators, a share of differential privacy noise generated based on the noise generation data, wherein the share of the differential privacy noise is generated by obtaining multiple subsamples from a negative binomial distribution using input parameters comprising a ratio between a scaling factor and the number of noise generators;
combining each share of noise received from the two or more noise generators to obtain total noise; and
applying the noise to data of a dataset.

2. The computer-implemented method of claim 1, wherein:
the ratio between a scaling factor and the number of noise generators comprises a number of successes parameter for the negative binomial distribution; and
the input parameters comprise a success probability parameter.

3. The computer-implemented method of claim 2, wherein the success probability parameter is equal to (1−e^{-α}).

4. The computer-implemented method of claim 1, wherein the scaling factor has a value less than one.

5. The computer-implemented method of claim 1, wherein:
the multiple subsamples comprise two subsamples; and
the share of the differential privacy noise is generated by determining a difference between the two subsamples.

6. The computer-implemented method of claim 1, wherein the share of the differential privacy noise is generated by obtaining multiple subsamples from a gamma distribution.

7. The computer-implemented method of claim 6, wherein:
the multiple subsamples from a negative binomial distribution comprise two subsamples from the negative binomial distribution;
the multiple subsamples from the gamma distribution comprise two subsamples from the gamma distribution; and
the share of the differential privacy noise is generated by:
determining a first difference between the two subsamples from the negative binomial distribution;
determining a second difference between the two subsamples from the gamma distribution; and
determining a sum of the two differences.

8. The computer-implemented method of claim 7, wherein determining the sum of the two differences comprises scaling the first difference prior to determining the sum.

9. The computer-implemented method of claim 1, wherein obtaining multiple subsamples from a negative binomial distribution comprises obtaining the multiple subsamples at different scales.

10. The computer-implemented method of claim 9, wherein:
the multiple subsamples from the negative binomial distribution comprise two subsamples from the negative binomial distribution; and
the share of the differential privacy noise is generated by:
for each different scale, determining a difference between the two subsamples for the scale; and
determining a sum of the differences.

11. The computer-implemented method of claim 10, wherein the share of the differential privacy noise is generated by obtaining two subsamples from a gamma distribution.

12. The computer-implemented method of claim 11, wherein the share of the differential privacy noise comprises a sum of (i) a difference between the two subsamples from a gamma distribution and (ii) the sum of the differences.

13. A system comprising:
one or more processors; and
one or more storage devices storing instructions that, when executed by the one or more processors, cause the one or more processors to perform operations comprising:
sending, to each noise generator or multiple noise generators, noise generation data comprising differential privacy parameters and a number of noise generators that are generating shares of differential privacy parameters;
receiving, from two or more of the noise generators, a share of differential privacy noise generated based on the noise generation data, wherein the share of the differential privacy noise is generated by obtaining multiple subsamples from a negative binomial distribution using input parameters comprising a ratio between a scaling factor and the number of noise generators;
combining each share of noise received from the two or more noise generators to obtain total noise; and
applying the noise to data of a dataset.

14. The system of claim 13, wherein:
the ratio between a scaling factor and the number of noise generators comprises a number of successes parameter for the negative binomial distribution; and
the input parameters comprise a success probability parameter.

15. The system of claim 14, wherein the success probability parameter is equal to (1−e^{-α}).

16. The system of claim 13, wherein the scaling factor has a value less than one.

17. The system of claim 13, wherein:
the multiple subsamples comprise two subsamples; and
the share of the differential privacy noise is generated by determining a difference between the two subsamples.

18. The system of claim 13, wherein the share of the differential privacy noise is generated by obtaining multiple subsamples from a gamma distribution.

19. The system of claim 18, wherein:
the multiple subsamples from a negative binomial distribution comprise two subsamples from the negative binomial distribution;
the multiple subsamples from the gamma distribution comprise two subsamples from the gamma distribution; and
the share of the differential privacy noise is generated by:
determining a first difference between the two subsamples from the negative binomial distribution;
determining a second difference between the two subsamples from the gamma distribution; and
determining a sum of the two differences.

20. A non-transitory computer readable storage medium carrying instructions that, when executed by one or more processors, cause the one or more processors to perform operations comprising:
sending, to each noise generator or multiple noise generators, noise generation data comprising differential privacy parameters and a number of noise generators that are generating shares of differential privacy parameters;
receiving, from two or more of the noise generators, a share of differential privacy noise generated based on the noise generation data, wherein the share of the differential privacy noise is generated by obtaining multiple subsamples from a negative binomial distribution using input parameters comprising a ratio between a scaling factor and the number of noise generators;
combining each share of noise received from the two or more noise generators to obtain total noise; and
applying the noise to data of a dataset.
